(19) United States
(12) Patent Application Publication
(10) Pub. No.: US 2005/0057537 A1
(43) Pub. Date: Mar. 17, 2005

(54) Transmission device for a two dimensional image display module to programmably display an image in the module

(76) Inventor: Chris Chen, Chino Hills, CA (US)

Correspondence Address: VENABLE, BAETJER, HOWARD AND CIVILETTI, LLP, P.O. BOX 34385, WASHINGTON, DC, 20043-9998, US

(21) Appl. No.: 10/649,615

(22) Filed: Aug. 28, 2003

(51) Int. Cl. G09G 5/00

(52) U.S. Cl. 345/204

(57) ABSTRACT

A transmission device for a 2D image display module includes a securing member for securing the backboard and the lens, a programmable step motor adapted to be mounted on the bottom face of the box for driving the backboard to move relative to the lens; whereby the backboard is able to be moved in a pre-programmed manner such that images in the 2D image display module are able to be presented in a desired manner.

### BACKGROUND OF THE INVENTION

1. Field of the Invention

The present invention relates to a transmission device, and more particularly to a transmission device for a two dimensional (2D) image display module to display an image in the 2D image display module.

2. Description of Related Art

With reference to FIGS. 6 and 7, a conventional two dimensional (2D) image display module has a pattern (20) movably sandwiched between a substrate (10) and a lens (30). A transmission device (40) having a cam (41) rotatably mounted on the backboard plate (30) and two arms (42) pivotally connected to the lens (30). Distal ends of each of the two arms (42) are connected to the cam (41) such that when the cam (41) is rotated, the two arms (42) are able to pivot relative to the lens (30). Because the other distal ends of the two arms (42) are engaged with the pattern (20), when the two arms (42) are pivoted, the pattern (20) is moved upward and downward repeatedly. The pattern (20) is thus able to present different pictures backboardd on the angle selected via the lens (30).

It is noted from the conventional transmission device (40) that after the two arms (42) are pivoted, the pattern (20) falls back to its original position by gravity. When the humidity in the air becomes dense, the movement of the pattern (20) becomes sluggish and sometimes may not maintain in its original space, which results in that the observer can not have a very clear image in that the image presenting angle between the pattern (20) and the lens (30) is mis-aligned.

Still further, after the pattern (20) is first inserted between the lens (30) and the substrate (10), calibration of the image presenting angle between the pattern (20) and the lens (30) has to be done manually. That is, the operator has to move around the pattern (20) with the lens (30) fixed or the lens (30) with the pattern (20) moved so as to have the best image presenting angle, which is quite troublesome and inefficient.

To overcome the shortcomings, the present invention intends to provide an improved transmission device to mitigate or obviate the aforementioned problems.

### SUMMARY OF THE INVENTION

The primary objective of the invention is to provide an improved transmission device for a 2D image display module. The transmission device is securely mounted on a substrate to drive either the backboard or the lens of the 2D image display module to move in a desired direction such that the image is able to be presented in a desired manner.

To accomplish the foregoing objective, the transmission device of the present invention includes a step motor securely mounted on the center of the box, securing rods each extending from the bottom face of the box and out of the backboard and the lens. To correspond to the securing rods, the backboard has first elongated holes defined in opposite sides of the backboard and the lens has second elongated holes defined in opposite sides of the lens. Each of the first elongated hole corresponds to and communicates with one of the second elongated holes such that the securing rods are able to extend through the backboard and the lens. Each of the first elongated holes has a dimension smaller than that of each of the second elongated holes.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the transmission device of the present invention;

FIG. 2 is a side view in cross section showing the relative position between the transmission device and the backboard at its first position when the transmission device is driving the backboard;

FIG. 3 is top plan view showing the relative position between the backboard and the lens when the backboard is driven by the transmission device of the present invention;

FIGS. 4 is a schematic view in cross section showing the relative position between the transmission device of the present invention and the backboard after the backboard is driven to move to a second position; and

FIG. 5 is a schematic top plan view showing that the backboard is moved to its second position relative to the lens.

### DETAILED DESCRIPTION OF PREFERRED EMBODIMENT

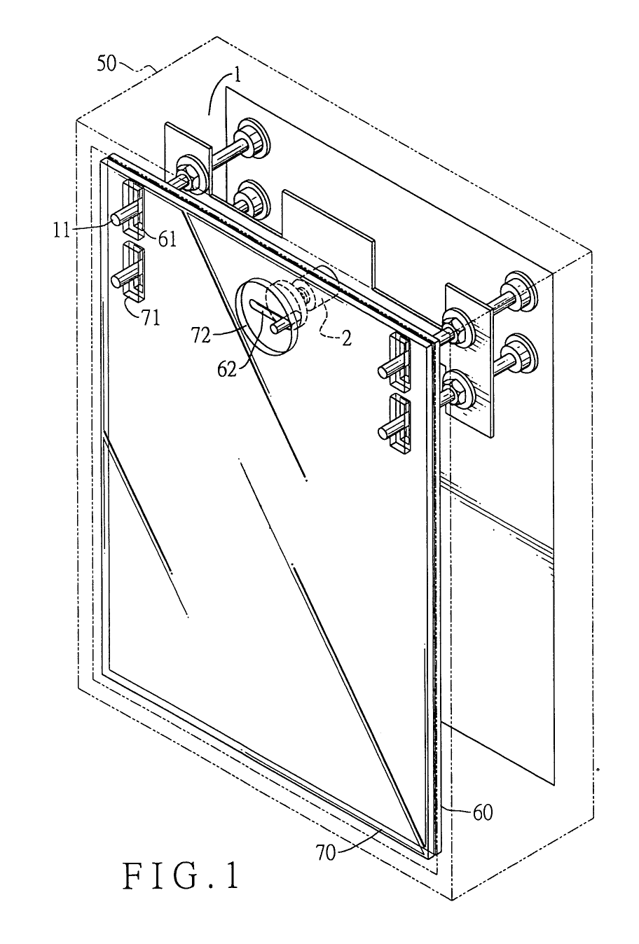

With reference to FIG. 1, a two dimensional (2D) image display module is composed of a box (50) with a top opening, a lens (70) and a backboard (60) sandwiched between the lens (70) and a bottom face defining the top opening of the box (50). A pattern (not shown) is normally attached to a top side of the backboard (60) to face the lens (70). The transmission device in accordance with the present invention has a securing member (1) and a programmable step motor (2).

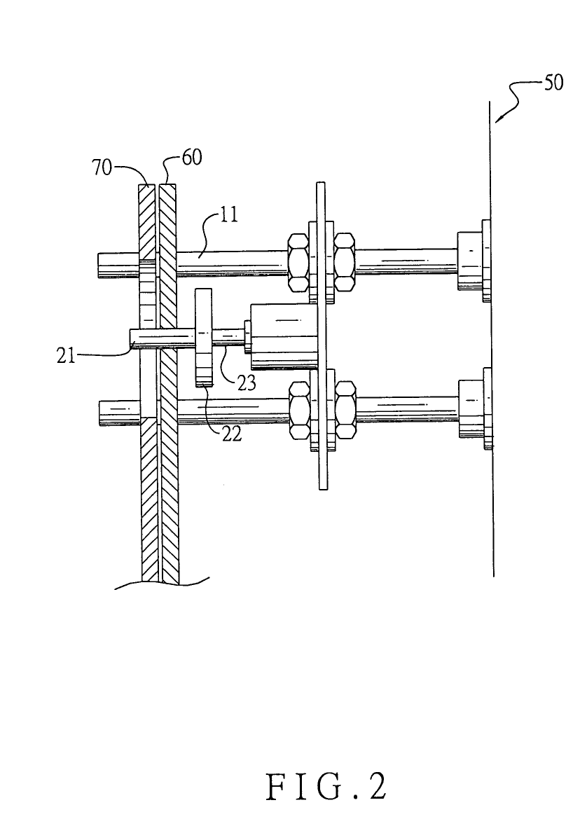

With reference to FIG. 2 and still taking FIG. 1 for reference, the securing member (1) has securing rods (I1) each extending from the bottom face of the box (50) and out of the backboard (60) and the lens (70). To correspond to the securing rods (11), the backboard (60) has first elongated holes (61) defined in opposite sides of the backboard (60) and the lens (70) has second elongated holes (71) defined in opposite sides of the lens (70). Each of the first elongated hole (61) corresponds to and communicates with one of the second elongated holes (71) such that the securing rods (11) are able to extend through the backboard (60) and the lens (70). Each of the first elongated holes (61) has a dimension smaller than that of each of the second elongated holes (71).

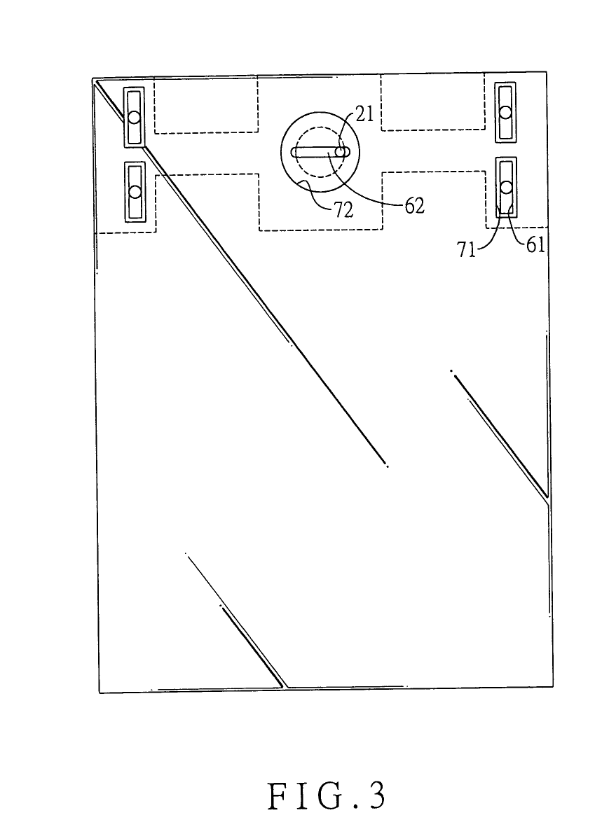

The programmable step motor (20) has a driving rod (21) eccentrically formed on a disk (22) which is securely formed with the motor shaft (23). The driving rod (21) extends into a long hole (62) in the backboard (60) and a hole (72) in the lens (70), which is shown in FIG. 3.

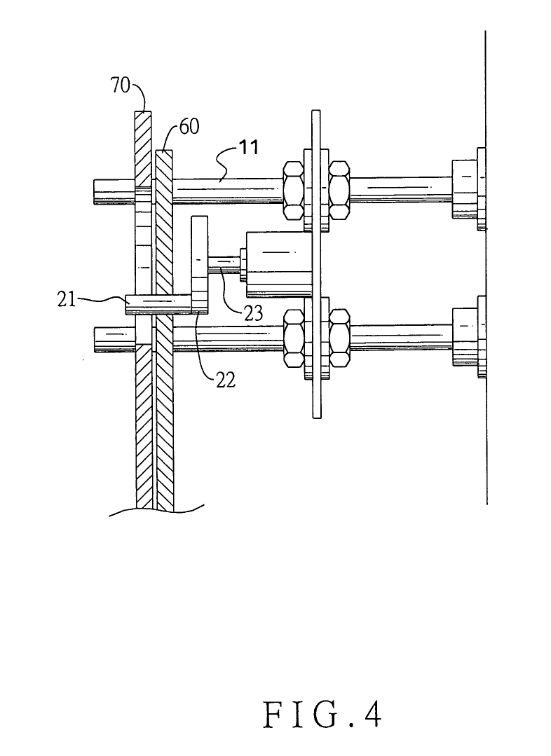

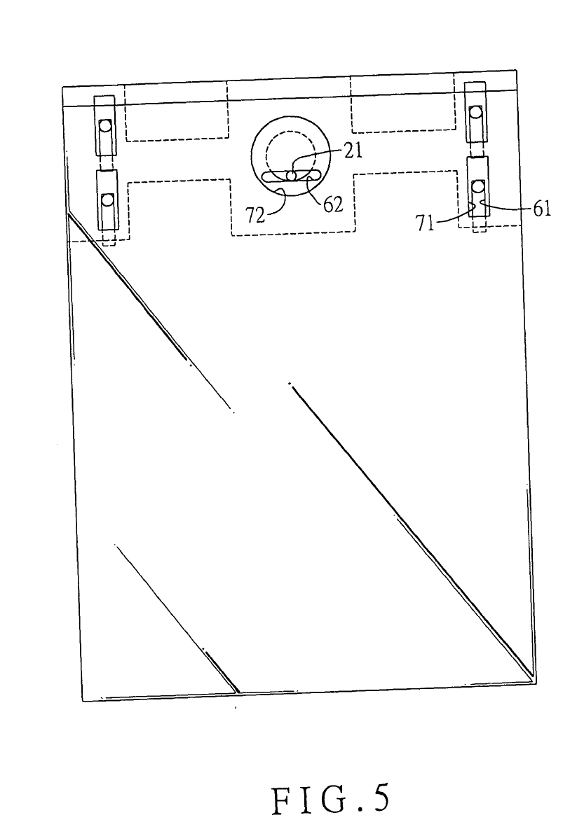

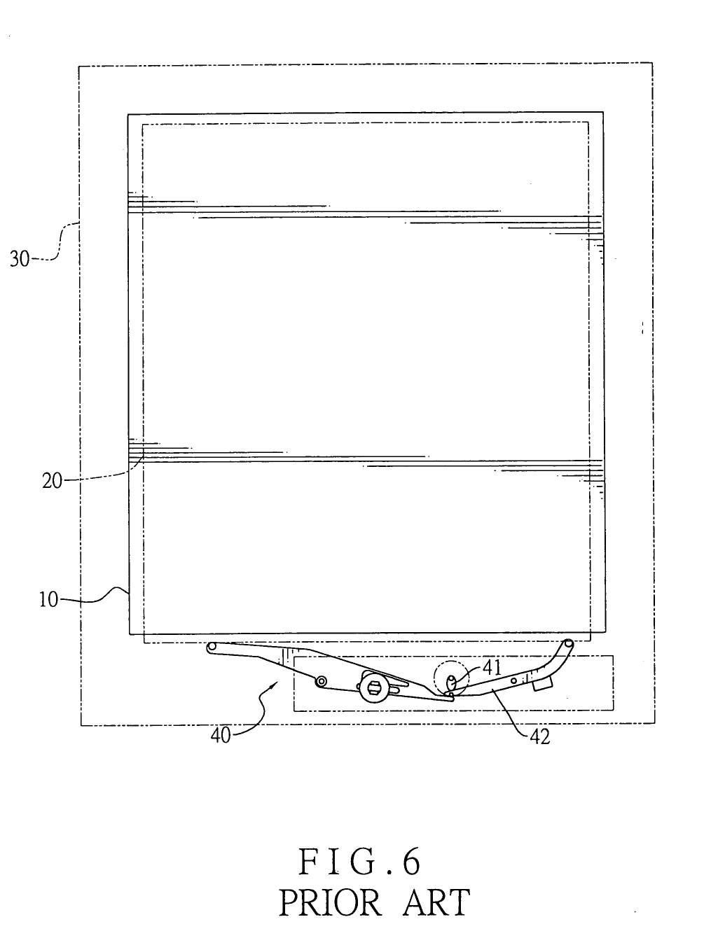

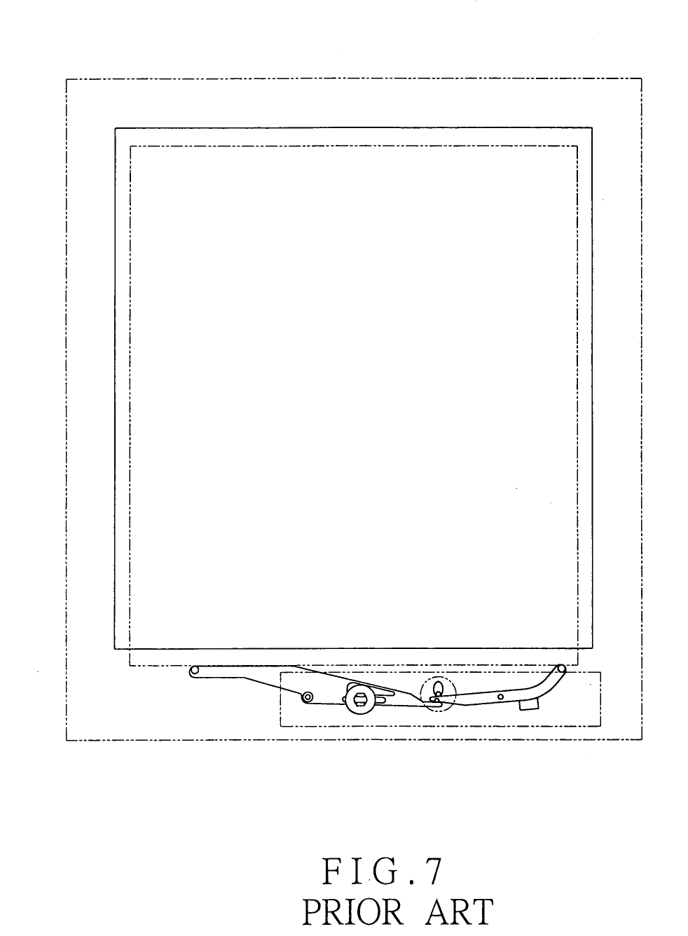

With reference to FIGS. 4, 5 and taking FIG. 2 for comparison, it is noted that when the programmable step motor (2) is activated and thus the driving rod (21) is driven to rotate by the disk (22) to move from a first position to a second position, the driving rod (21) is able to freely move in the hole (72) of the lens (70). However, because of the limitation of the long hole (62) in the backboard (60), the rotational movement of the eccentrically formed driving rod (21) will thus drive the backboard (60) to move relative to the lens (70) from its first position to the second position. That is to say, the backboard (60) is able to move up and down with respect to the lens (70) due to the limitation of the long hole (62) in the backboard (60).

Because the movement of the backboard (60) in respect to the lens (70), the picture (or pattern) sandwiched between the backboard (60) and the lens (70) is able to present itself in a pre-programmed manner. That is, the picture may contain several different images arranged in different positions in the picture. When the backboard (60) is driven to move in different manners as a result of the program chosen from the programmable step motor (2), the images may be presented in continuous sequence, in alternate sequence, forwardly, backwardly . . . etc.

In summary, due to the transmission structure of the present invention, the images in the picture are able to be presented via the 2D image display module in different manners.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A transmission device for a two dimensional (2D) image display module having a box with a top opening, a lens received in the box and a backboard sandwiched between a bottom face defining the top opening of the box and the lens, the transmission device comprising:
a securing member adapted to be formed on a bottom face defining the top opening of the box for securing the backboard and the lens;
a programmable motor adapted to be mounted on the bottom face of the box for driving the backboard to move relative to the lens;
whereby the backboard is able to be moved in a pre-programmed manner such that images in the 2D image display module are able to be presented in a desired manner.

2. The transmission device as claimed in claim 1, wherein first elongated holes are defined in opposite sides of the backboard and second elongated holes are defined in opposite sides of the lens to correspond to the first elongated holes.

3. The transmission device as claimed in claim 1, wherein the securing member has securing rods adapted to extend from the bottom face of the box, the securing rods extend through the first elongated holes and the second elongated holes such that the backboard and the lens are secured relative to the box.

4. The transmission device as claimed in claim 2, wherein the securing member has securing rods adapted to extend from the bottom face of the box, the securing rods extend through the first elongated holes and the second elongated holes such that the backboard and the lens are secured relative to the box.

5. The transmission device as claimed in claim 1, wherein the programmable step motor has a disk securely connected to a motor shaft extending out of the programmable step motor, an eccentrically formed driving rod on the disk extendable through the backboard and the lens such that the programmable step motor is able to drive the backboard to move relative to the lens.

6. The transmission device as claimed in claim 4, wherein the programmable step motor has a disk securely connected to a motor shaft extending out of the programmable step motor, an eccentrically formed driving rod on the disk extendable through the backboard and the lens such that the programmable step motor is able to drive the backboard to move relative to the lens.

7. The transmission device as claimed in claim 6, wherein al long hole is adapted to be defined in the backboard to correspond to the driving rod and a hole is adapted to be defined in the lens to correspond to the driving rod, thereby the eccentrically formed driving rod is able to drive the backboard to move linearly relative to the lens.

8. The transmission device as claimed in claim 7, wherein each of the first elongated holes of the backboard has a dimension smaller than that of each of the second elongated holes of the lens such that after the driving rods extend through the first and second elongated holes, movement of the backboard relative to the lens is linear.

9. A transmission device for a two dimensional (2D) image display module having a box with a top opening, a lens received in the box and a backboard sandwiched between a bottom face defining the top opening of the box and the lens, the transmission device comprising:
a securing member adapted to be formed on a bottom face defining the top opening of the box for securing the backboard and the lens;
a programmable motor adapted to be mounted on the bottom face of the box for driving the lens to move relative to the backboard;
whereby the backboard is able to be moved in a pre-programmed manner such that images in the 2D image display module are able to be presented in a desired manner.

10. The transmission device as claimed in claim 9, wherein first elongated holes are defined in opposite sides of the backboard and second elongated holes are defined in opposite sides of the lens to correspond to the first elongated holes.

11. The transmission device as claimed in claim 9, wherein the securing member has securing rods adapted to extend from the bottom face of the box, the securing rods extend through the first elongated holes and the second elongated holes such that the backboard and the lens are secured relative to the box.

12. The transmission device as claimed in claim 10, wherein the securing member has securing rods adapted to extend from the bottom face of the box, the securing rods extend through the first elongated holes and the second elongated holes such that the backboard and the lens are secured relative to the box.

13. The transmission device as claimed in claim 9, wherein the programmable step motor has a disk securely connected to a motor shaft extending out of the programmable step motor, an eccentrically formed driving rod on the disk extendable through the backboard and the lens such that the programmable step motor is able to drive the backboard to move relative to the lens.

14. The transmission device as claimed in claim 12, wherein the programmable step motor has a disk securely connected to a motor shaft extending out of the programmable step motor, an eccentrically formed driving rod on the disk extendable through the backboard and the lens such that the programmable step motor is able to drive the backboard to move relative to the lens.

15. The transmission device as claimed in claim 14, wherein al long hole is adapted to be defined in the backboard to correspond to the driving rod and a hole is adapted to be defined in the lens to correspond to the driving rod, thereby the eccentrically formed driving rod is able to drive the backboard to move linearly relative to the lens.

16. The transmission device as claimed in claim 15, wherein each of the first elongated holes of the backboard has a dimension smaller than that of each of the second elongated holes of the lens such that after the driving rods extend through the first and second elongated holes, movement of the backboard relative to the lens is linear.
